(19) United States
(12) Patent Application Publication
(10) Pub. No.: US 2018/0247381 A1
(43) Pub. Date: Aug. 30, 2018

(54) SMART FOOD-LINE SYSTEM

(71) Applicant: Panasonic Intellectual Property Management Co., Ltd., Osaka (JP)

(72) Inventors: John CRONIN, Bonita Springs, FL (US); Joseph BODKIN, South Burlington, VT (US)

(21) Appl. No.: 15/906,658

(22) Filed: Feb. 27, 2018

Related U.S. Application Data
(60) Provisional application No. 62/464,701, filed on Feb. 28, 2017.

(51) Int. Cl. G06Q 50/12; G06Q 20/40; G06Q 20/20

(52) U.S. Cl. CPC G06Q 50/12; G06Q 20/40; H04W 84/12; G06Q 20/204; G06Q 20/202

(57) ABSTRACT

Food-line management is provided through a smart food line management system that includes a wait device, a kitchen terminal device, and a food network server. The wait device stores a unique identifier and includes a user interface for receiving a menu selection. The kitchen terminal device includes a user interface. The food network server includes a network communication interface that communicates with the wait device and the kitchen terminal device across the communication network. The food network server receives a user input menu selection and the unique identifier of the wait device, retrieves from a database a current wait time associated with the unique identifier and an estimated time to prepare the user-selected menu item and, upon determining that the current wait time is less than the estimated time to prepare the menu item, transmits an order for the menu item to the kitchen terminal device.

### CROSS-REFERENCE TO RELATED APPLICATION

This application claims priority from U.S. Provisional Application No. 62/464,701, filed on Feb. 28, 2017, the disclosure of which is incorporated by reference herein in its entirety.

### TECHNICAL FIELD

The present disclosure generally relates to food lines. In particular, the present disclosure relates to smart food-line management.

### DESCRIPTION OF THE RELATED ART

Many theme parks, resorts, and similar types of service providers make available a variety of restaurants, food counters, bars, and other eateries to their guests. Some of these eateries may be very popular with the guests, leading to long lines and associated wait times in order to obtain food. Such long lines and wait times are an inconvenience to the guests, however, leading to a less optimal guest experience.

There is, therefore, a need in the art for improved systems and methods for smart food-line management.

### SUMMARY

Embodiments of the present disclosure include systems and methods for smart food-line management.

An exemplary system for smart food-line management may include a plurality of wait devices, a beacon associated with a table, a kitchen or bar terminal, and a food network server. Each wait device includes a memory storing a unique identifier and a wireless network communication interface configured to communicate the unique identifier over a communication network. The beacon is configured to communicate wirelessly with a wait device of the plurality of wait devices within a communication range of the beacon. The kitchen or bar terminal includes a user interface and a network communication interface configured to communicate over the communication network. The food network server includes a network communication interface configured to communicate wirelessly with the plurality of wait devices and to communicate with the kitchen or bar terminal. The food network server is configured to receive, via the communication interface of the food network server, a communication from at least one of the plurality of wait devices and the beacon that a particular wait device is within a communication range of the beacon, where the received communication includes the unique identifier stored by the particular wait device. The food network server is then configured to transmit to the kitchen or bar terminal, via the network communication interfaces of the kitchen or bar terminal and of the food network server, location information for the particular wait device determined based on the received communication indicating that the particular wait device is within the communication range of the beacon.

According to another aspect of the disclosure, a system for smart food-line management may include a wait device, a kitchen terminal device, and a food network server. The wait device includes a memory storing a unique identifier, a user interface configured to receive a user input selection, and a network communication interface configured to communicate wirelessly over a communication network. The kitchen terminal device includes a user interface and a network communication interface configured to communicate over the communication network. The food network server includes a network communication interface configured to communicate with the wait device and the kitchen terminal device across the communication network. The food network server is configured to receive via the user device a user input selection of a menu item and the unique identifier of the wait device. In response to receiving the user input selection of the menu item and the unique identifier of the wait device, the food network server retrieves from a database a current wait time associated with the unique identifier of the wait device and an estimated time to prepare the menu item of the user input selection. In turn, upon determining that the current wait time is less than the estimated time to prepare the menu item, the food network server transmits an order for the menu item of the user input selection to the kitchen terminal device.

According to a further aspect of the disclosure, a system for smart food-line management includes a plurality of wait devices, a kitchen or bar terminal, and a food network server. Each wait device includes a memory storing a unique identifier and a wireless network communication interface configured to communicate the unique identifier over a communication network. The kitchen or bar terminal includes a network communication interface configured to communicate over the communication network. The food network server includes a network communication interface configured to communicate wirelessly with the plurality of wait devices and to communicate with the kitchen or bar terminal. The food network server further includes a memory configured to store information on available tables including location information of the available tables. Each respective wait device is configured to receive, from the food network server, the information on the available tables; receive, using a user interface of the respective wait device, a user input selection of a table among the available tables; and communicate, using the wireless network communication interface of the respective wait device, the user input selection of the table to the food network server over the communication network. The food network server is configured to receive user input selections of tables from the plurality of wait devices and, in response to receiving a user input selection of a particular table from one of the plurality of wait devices, transmit to the kitchen or bar terminal, via the network communication interfaces of the food network server and the kitchen or bar terminal, location information of the particular table and the unique identifier of the one wait device.

### BRIEF DESCRIPTION OF THE DRAWINGS

FIG. 1 illustrates an exemplary network environment in which a system for smart food-line management may be implemented.

FIG. 2A illustrates an exemplary wait device that may be used in a system for smart food-line management.

FIG. 2B illustrates an exemplary table beacon that may be used in a system for smart food-line management.

FIG. 3 is a flowchart illustrating an exemplary food network server method that may be performed in a system for smart food-line management.

FIG. 4 is a flowchart illustrating an exemplary method for smart food-line management.

FIGS. 5A-5D illustrate various wait device graphic user interfaces (GUIs) that may be used in a system for smart food-line management.

FIG. 6 is a flowchart illustrating an exemplary wait device method that may be used in a system for smart food-line management.

FIG. 7 illustrates an exemplary bar terminal GUI that may be used in a system for smart food-line management.

FIGS. 8A and 8B illustrate various host station device GUIs that may be used in a system for smart food-line management.

FIGS. 9A and 9B illustrate various kitchen device GUIs that may be used in a system for smart food-line management.

### DETAILED DESCRIPTION

Embodiments of the present disclosure include systems and methods for smart food-line management. An exemplary system for smart food-line management may include at least one wait device that communicates a unique identifier over a communication network to be stored in a remote database when a guest is seated; a food network server that receives the unique identifier, calculates a current wait time for the at least one wait device identified by the unique identifier, and sends the calculated wait time to the wait device; at least one table beacon that communicates with the food network server when the table is ready to be seated; and a buzzer that generates a notification signal when the calculated wait time has expired and when the table beacon indicates that the table is ready.

Such a system may be utilized with a dynamic low-cost menu and a wait device (e.g., as identified by a device identifier) associated with a smart buzzer. When a guest enters into a line, a waiting time may start being tracked. In the meantime, the guest may place an order through the wait device. During the wait, the guest can order drinks and/or food, and the order is sent to the bar and/or kitchen to be fulfilled. The smart buzzer may activate an alarm or other notification signal when a calculated wait time has expired. The guest may further take the wait device to the table when seated to continue the ordering process. The wait device communicates with a beacon associated with the table (e.g., as identified by a unique table identifier). In this way, the wait time in line may be concurrent with ordering. In some embodiments, credit cards may be swiped by the wait device (or an associated peripheral card swipe device), so that payment may be completed without human personnel as well. As such, fewer operators may be required to manage wait times and food delivery, thereby minimizing labor costs, maximizing profits, and serving customers more efficiently.

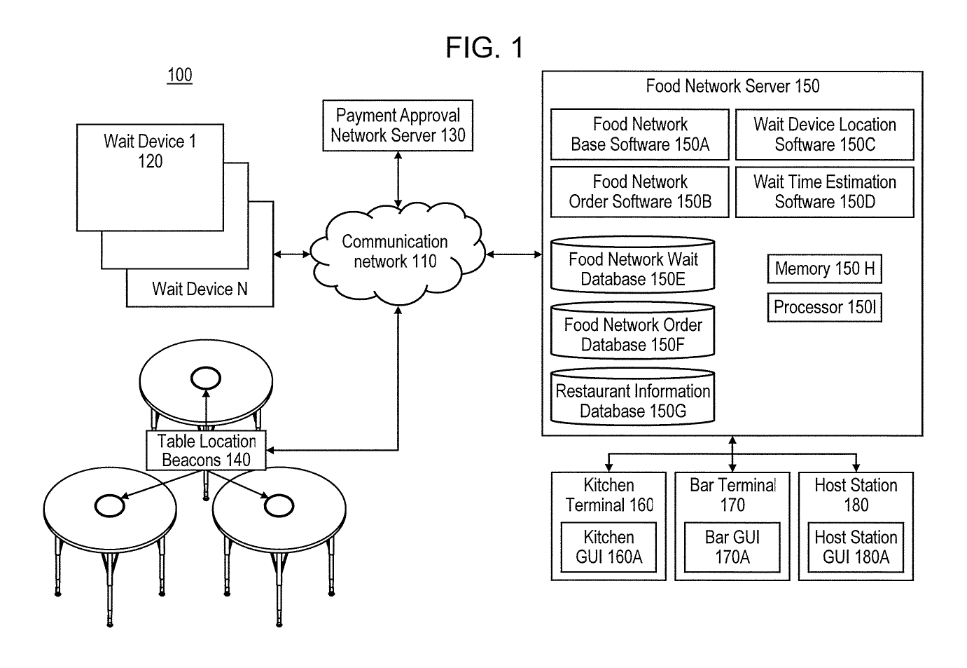

FIG. 1 illustrates an exemplary network environment in which a system for smart food-line management may be implemented. Network environment 100 may include communication network 110 through which wait devices 120, payment approval network server 130, table beacons 140, and food network server 150 (which is further in communication with kitchen terminal 160, bar terminal 170, and host station 180) may communicate with each other. The system allows for managing wait times in an eatery in a way that enables patrons to see the time remaining until they are seated, as well allow patrons to order (e.g., drinks) to be delivered in line while waiting or to be delivered to their table at the expected seating time.

Communication network 110 may be a local, proprietary network (e.g., an intranet) and/or may be a part of a larger wide-area network. The communications network 110 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 110 allows for communication between the various components of network environment 100.

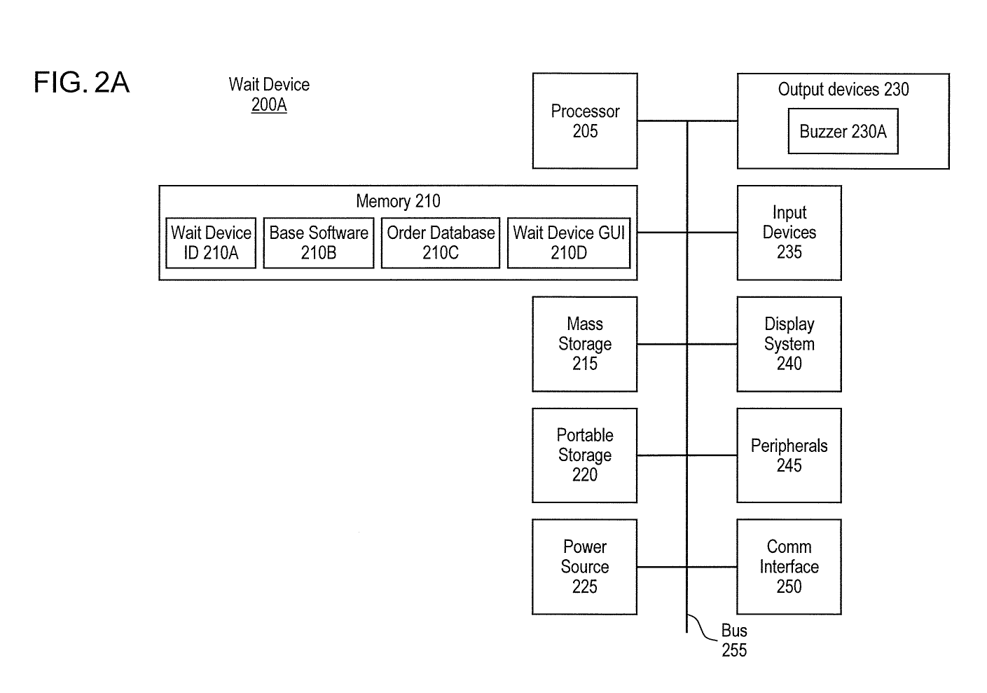

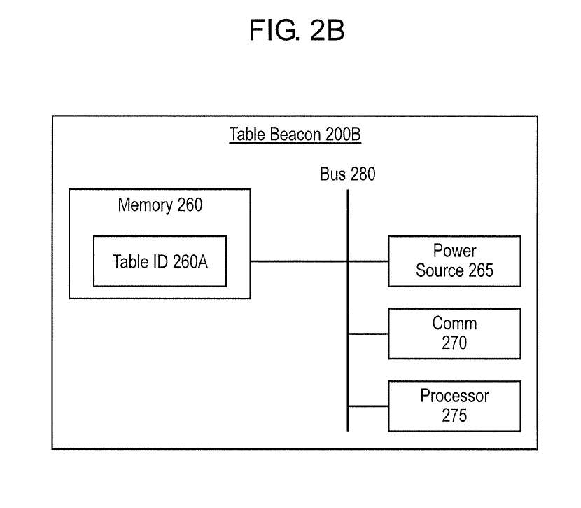

Wait devices 120 may be any type of communication device known in the art, including mobile phones, smartphones, personal digital assistants (PDAs), portable computing devices (e.g., laptop, netbook, tablets), handheld computing device, or any other type of computing device capable of communicating over communication network 110. Wait device 120 is described in further detail with respect to FIG. 2A herein.

A wait device 120 may be issued to a patron by a host at the host station 180 when the patron arrives at the restaurant (e.g., restaurant, food court, or other food service location) and checks in with the host. As part of the guest check-in, the host may also enter a device identification number of the wait device 120 issued to the patron and a number of patrons in the patron's party into the host station GUI 180A of the host station device 180. Such information may be provided to food network server 150 for generation of wait time estimations.

Payment approval network server 130 may perform payment approval services for various types of payment, including various types of credit cards, electronic payment systems, etc.

Table location beacons 140 may include various types of beacons. In particular, table location beacons 140 communicate information regarding the location of the table, which may be used to determine that a patron (with an associated wait device 120) is sufficiently close to the table and its beacon (e.g., within a communication range of the beacon) as to be considered seated at the table.

Food network server 150 may include various types of servers or other computing devices, and may include hardware computing components such as network and media interfaces, non-transitory computer-readable storage (memory 150H), and one or more processor(s) 150I for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

Food network server 150 may include food network base software 150A, food network order software 150B, wait device location software 150C, wait time estimation software 150D, food network wait database 150E, food network order database 150F, restaurant information database 150G, memory 150H, and processor 150I. Food network base software 150A—as well as food network order software 150B, wait device location software 150C, and wait time estimation software 150D—includes instructions embodied in non-transitory computer-readable storage media. The wait device 120 may also store an estimated wait time in local memory.

Execution of the food network base software 150A may begin (or be triggered) when the host station device 180 checks a patron in and a wait time device 120 is activated. The host station device 180 may transmit the patron check-in information, including the device identification number of the wait device 120 issued to the patron and a number of patrons in the patron's party, to the food network base software 150A of the food network server 150. In turn, information—such as a wait time estimate, and bar and/or kitchen menus—may be retrieved from the restaurant information database 150G and transmitted from the food network server 150 to the activated wait device 120 over the communication network 110. In response to receiving the wait time estimate and menus in the wait device 120, the estimated wait time and buttons to launch the bar and/or kitchen menus may be displayed to the patron on a GUI of the wait device 120.

The wait device 120 may further be polled for a user selection (e.g., as to food or drink order). If the user makes a selection through the GUI of the wait device 120, the wait device 120 communicates the user selection to the food network server 150 through the communication network 110. The food network order module 150B may be launched in response to receiving the user selection in the food network server 150. In the meantime, updated wait times may be continually retrieved from or computed based on data from the restaurant information database 150G, and the updated wait times may be provided to the wait device 120. The restaurant information database 150G may store information regarding the restaurant, such as a map of the establishment, kitchen menu, bar menu, current device locations, current table status, time to prepare menu items, and estimated wait time for each wait device (e.g., as produced by the wait time estimation software 150D, which may be continuously executed in the food network server 150 to provide wait time estimates updated in real time).

Next, it may be determined whether the wait device 120 has contacted a table beacon 140 or received a beacon signal transmitted by a table beacon 140. If the wait time device 120 has contacted a table beacon 140 (or received a beacon signal transmitted by a table beacon 140 that includes a unique identifier for the table beacon 140), the wait time device 120 sends a notification to the food network server 150 to indicate that a table beacon 140 has been detected. The notification includes both the device identification number of the wait device 120 and the unique identifier for the table beacon 140 that was transmitted by the table beacon 140. In response to receiving the notification in the food network server 150, the food network server 150 may update the restaurant information database 150G to reflect that the patron associated with the wait device 120 is seated at the table associated with the received table beacon 140. If the wait device 120 has not contacted a table beacon 140 (or has not received a beacon signal transmitted by a table beacon 140), the food network server 150 may determine whether a table is ready for use by the patron associated with the wait device 120. In particular, the food network server 150 may determine whether any table identified in the restaurant information database 150G is identified as being available and as having sufficient space for the number of patrons in the patron's party. If a table is ready, a notification is transmitted from the food network server 150 to the wait device 120 of the patron to cause a message “table ready” to be displayed on the GUI of the wait device 120. Further, the restaurant information database 150G may be updated to indicate that the identified table is now occupied by the patron and the patron's party.

In general, the food network server 150 maintains in the restaurant information database 150G information on tables located in the restaurant or food service establishment. The table information can include a location for each table, a capacity (e.g., number of seats) at each table, and an indicator regarding the current status or availability of each table (e.g., occupied, requiring clearing/cleaning, or available). The table information, including the information on the current status or availability of each table, can be updated in a number of ways. Restaurant staff (e.g., waiters, cleaning staff, hosts, etc.) may provide updated table status or availability information through the host station GUI 180A, a kitchen or bar GUI (160A, 170A), or through a wireless user device operated by the staff member. Alternatively, updated table status or availability information can be provided automatically through a table status determination performed by the food network server 150 based on sensing data gathered by a network of sensors such as cameras, table beacons, or other sensors (e.g., cameras which may determine through image analysis whether a table has been cleared, wireless sensors configured to determine whether seats are empty, or the like). Updated table status or availability can also automatically be determined by the food network server 150 based on determining that a patron currently seated at a table has completed payment for their meal.

If the wait device 120 has not contacted a table beacon 140 and no tables are yet ready, the wait device 120 may continue to poll its GUI for a user selection. In this fashion, the user can launch execution of the food network order software module 150B at any time including while waiting for a table or once seated at (or assigned to) a table.

Execution of the food network order software 150B may begin (or be triggered) upon receipt of a prompt or a user selection from the food network base software 150A. For example, in response to receiving a user selection for a menu item from a patron through the GUI of the wait device 120, the user selection may be transmitted to the food network server 150 and cause the food network base software 150A executed in the server 150 to trigger execution of the food network order software 150B. Execution of the food network order software 150B may trigger a payment request routine to be activated to as to request payment for the user-selected menu item through the wait device 120. In particular, in response to execution of the food network order software 150B, a payment screen may be displayed on the GUI of the wait device 120. The wait device 120 may further be polled for any user entry of a payment method, which may include “tap to pay” input from a tap-to-pay sensor of the wait device 120, entry of payment information into dialogue boxes (e.g., on the GUI), receipt of payment data from a physical card reader, a magnetic strip, or a chip reader of the wait device 120 (or other payment terminal), and any other types of appropriate payment.

Once a payment method is received by the food network order software 150B, the received payment information may be sent via the communication network 110 to the payment approval network server 130 (e.g., associated with Visa, American Express, etc.) in order to confirm validity of the payment information and process the payment. Once the payment method has been approved, the food network base software 150A—and food network order software 150B—may determine if the user-selected item(s) are from the kitchen or the bar. If the order is for items from the bar menu, the order and position of the wait device 120 are sent to the bar terminal 170 and displayed on the bar terminal GUI 170A. If the order is from the kitchen menu, the updated wait time estimate and time to prepare the selection(s) may be retrieved from the restaurant information database 150G. When the wait time is less than the time to prepare selection(s), the order may be transmitted to the kitchen terminal 160 to be displayed on the kitchen GUI 160A. The user inputs—food order, drink order, payment information—may be stored in the food network wait database 150E and food network order database 150F.

In some embodiments, the wait device 120 can act as a calculator to allow user to determine size of potential bill as the user makes selection(s) or as a two-way communication terminal for transmitting and receiving details of order and other information. Data from waiting patrons can be analyzed over time to enhance menus. Wait devices 120 can supply advertisements and coupons over time (e.g., the longer the wait the more the benefits) based on wait time algorithms to help pacify frustrated guests who are waiting longer.

In some embodiments, once the payment method has been approved for a patron's food order, the food network base software 150A may provide updated table availability information to the wait device through which the food order (or other user selection for a menu item) was submitted. The updated table availability information can include information on one or multiple tables identified as being available in the restaurant information database 150G for presentation to a patron through the wait device's GUI. In cases in which no tables are available, the updated table availability information can be transmitted to the wait device when a table is determined/identified to be available. In cases in which multiple tables are available, the table availability information for the multiple tables can be transmitted to the wait device with a prompt for a user selection of one of the available tables. In turn, in response to receiving a user selection of one of the tables among the available tables (or in response to the system assigning an available table to the wait device), the food network base software 150A may provide identification of the assigned table to the kitchen or bar terminal along with identification of the user menu selection and wait device identifier.

As described above, the food network server 150 provides improved functionality that enables tables to be assigned to (or selected by) patrons automatically with no or minimal intervention by restaurant staff. Moreover, the wait devices and food network server enable patrons to place orders for food in advance of being seated, thereby enabling faster food service and more efficient use of restaurant facilities. Note that while table beacons are used in some embodiments described above, many functions provided by the food network server 150 and other systems described herein can be implemented even if no table beacons are provided.

FIG. 2A illustrates an exemplary wait device 200A that may be used in a system for smart food-line management. The wait device 200A of FIG. 2A includes one or more processors 205 and memory 210. Memory 210 stores, in part, instructions and data for execution by the processor 205, as well as a wait device identification number (or identifier) (ID) 210A, base software 210B, order database 210C, and wait device GUI 210D. Memory 210 can store the executable code when in operation. The wait device 200A of FIG. 2 further includes a mass storage device 215, portable storage medium drive(s) 220, power source 225, output devices 230 (including buzzer 230A), user input devices 235, a display system 240 including a graphics display, peripheral devices 245, and a communication interface 250.

The components shown in FIG. 2A are depicted as being connected via a single bus 255. However, the components may be connected through one or more data transport means. For example, processor(s) 205 and memory 210 may be connected via a local microprocessor bus, and the mass storage device 215, peripheral device(s) 245, portable storage device 220, and display system 240 may be connected via one or more input/output (I/O) buses.

Mass storage device 215, which may be implemented with a magnetic disk drive or an optical disk drive, is a non-volatile storage device for storing data and instructions for use by processor unit 205. Mass storage device 215 can store the system software for implementing embodiments described herein for purposes of loading that software into memory 210.

Portable storage device 220 operates in conjunction with a portable nonvolatile storage medium, such as a floppy disk, compact disk or digital video disc, to input and output data and code to and from the wait device 200A of FIG. 2A. The system software for implementing embodiments of the present invention may be stored on such a portable medium and input to the wait device 200A via the portable storage device 220.

Power source 225 may include various types of power sources including batteries, power cords/cables, USB and other connectors.

Additionally, the wait device 200A as shown in FIG. 2A includes output devices 230. Examples of suitable output devices include speakers, network interfaces, display screens, and buzzers 230A. Input devices 235 provide a portion of a user interface. Input devices 235 may include an alpha-numeric keypad, such as a keyboard, for inputting alpha-numeric and other information; a pointing device, such as a mouse, a trackball, stylus, or cursor direction keys; or a touch-sensitive display.

Display system 240 may include a liquid crystal display (LCD) or other suitable display device. Display system 240 receives textual and graphical information, and processes the information for output to the display device.

Peripherals 245 may include any type of computer support device to add additional functionality to the computer system. For example, peripheral device(s) 245 may include a modem, a router, and/or a transceiver such as a transceiver configured to receive beacon signals from table location beacons 140.

Communication interface 250 may include wired and/or wireless communication interfaces for communicating over any appropriate communication network. Such communication interfaces 250 may include not only Internet communications, but also Bluetooth, NFC, RFID, WiFi, etc.

FIG. 2B illustrates an exemplary table beacon 200B that may be used as a table location beacon 140 in a system for smart food-line management. Such a table beacon 200B may include memory 260 (that stores a table identifier 260A or other unique identifier for the table beacon 200B), a power source 265, communication interface 270, processor 275, and bus 280. The specific components may operate in accordance with their operations in wait device 200A as described above with respect to FIG. 2A.

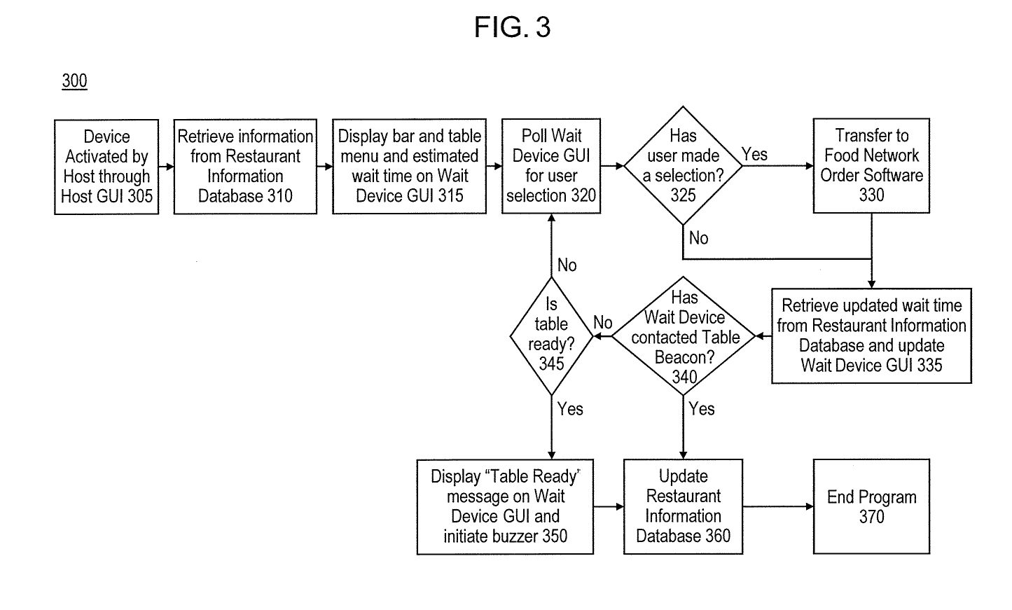

FIG. 3 is a flowchart illustrating an exemplary food network server operation method 300 that may be performed in a system for smart food-line management.

Method 300 may begin operation when the host station 180 checks a patron in and a wait device 120 is activated for the patron. Specifically, as part of the check-in process, the host station device 180 may transmit the patron check-in information, including the device identification number of the wait device 120 issued to the patron and a number of patrons in the patron's party, to the food network base software 150A of the food network server 150. In step 305, the food network base software 150A may begin execution in response to the host station 180 activating the wait device 120 (e.g., in response to receiving the patron check-in information in the food network server 150). In step 310, the food network base software 150A retrieves information—including a wait time estimate and bar and kitchen menu(s)—from the restaurant information database 150G and transmits the retrieved information to the wait device 120. In step 315, the wait device 120 receives the information and displays the estimated wait time and buttons to launch the bar and/or kitchen menu(s) on the wait device GUI 210D. In step 320, the wait device 120 monitors or polls the GUI 210D for a user selection. In step 325, the wait device 120 and/or the food network base software 150A determine whether a user selection has been received. If so, the method proceeds to step 330 with the wait device 120 transmitting the received user selection to the food network server 150. In the food network server 150, the food network base software 150A recognizes the received communication from the wait device as a user selection and sends the user selection to the food network order software 150B which may then begin execution. From there, the method may proceed to step 335. If no user selection is detected in step 325, the method proceeds directly to step 335 in which an updated wait time may be retrieved from the restaurant information database 150G and transmitted to the wait device 120 for display on the wait device GUI 120D. Note that step 335 may be periodically executed (e.g., every 5 minutes) when no user selection is received.

In step 340, the wait device 120 and/or the food network base software 150A determine whether the wait device 120 has contacted (or received a beacon signal from) a table beacon 140. If the wait device 120 has not contacted a table beacon 140, the method proceeds to step 345 in which the food network base software 150A determines whether a table is ready to have guests seated by consulting the restaurant information database 150G for any available tables. The food network base software 150A may in particular determine whether the restaurant information database 150G indicates any available table that has a capacity equal to or exceeding the number of guests in the patron's party. If no suitable table is ready, the method returns to step 320 for more monitoring or polling as to user selections. If a suitable table is ready in step 345, the method proceeds to step 350 in which the food network base software 150A transmits a table ready notification to the wait device to cause a message (e.g., “table ready”) to be displayed on the wait device GUI 210D and to cause activation of an associated buzzer 230A. The food network base software 150A may further update the restaurant information database 150G in step 360 to identify the suitable table as being reserved for imminent use by the patron.

If the wait device 120 not contacted a table beacon 140 in step 340, the method proceeds directly to step 360. The wait device 120 may transmit identification of the contacted table beacon to the food network base software 150A in the food network server 150 to cause the food network base software 150A to update the restaurant information database 150G to identify as occupied the table associated with the table beacon. Additionally, the restaurant information database 150G may be updated with a current estimated wait time based on the patron having been assigned a table and no longer being in the wait queue. In step 370, the method may end.

Note that while the description of method 300 details a particular ordering of the steps, the method may be implemented with a different ordering of the steps. For example, step 340 may be periodically performed (e.g., every minute) in order to promptly update the restaurant information database 150G as soon as a table beacon is received by a wait device 120. In another example, following step 360, steps 320, 325, and 330 may be cyclically performed to enable the patron to continue to order food and/or beverages using the wait device 120 while seated at the table.

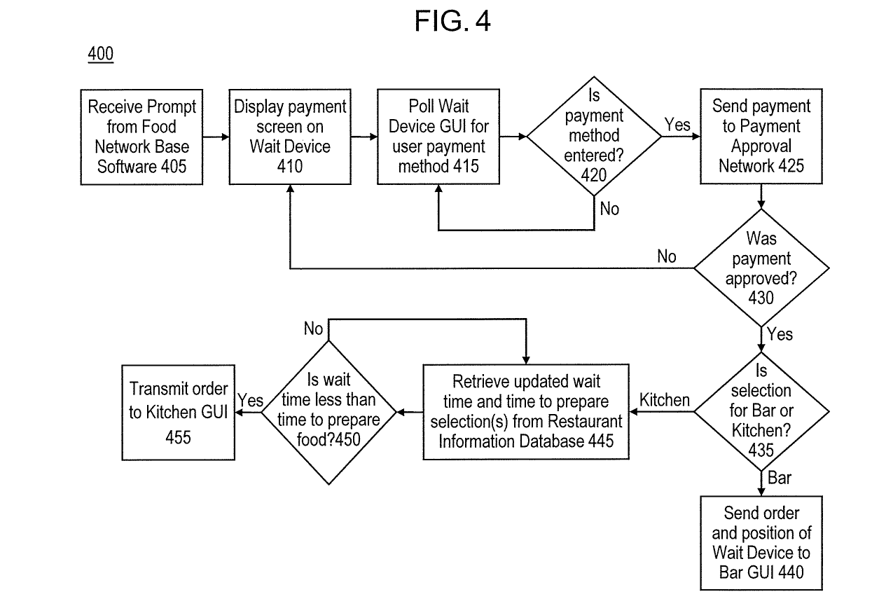

FIG. 4 is a flowchart illustrating an exemplary method 400 for smart food-line management.

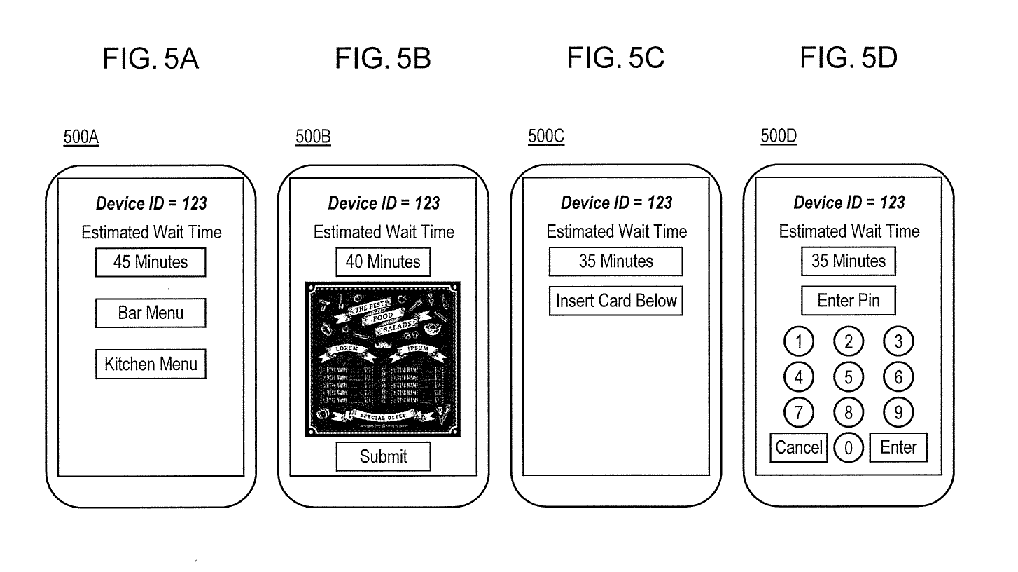

Method 400 may begin operation when the food network base software 150A activates the food network order software 150B, for example in step 330 of method 300. In step 405, execution of the food network order software 150B may begin upon receiving a user selection from the user (e.g., via the wait device GUI 210D and the food network base software 150A). In step 410, operation of the food network order software 150B causes the food network order software 150B to poll the wait device 120 for payment information. Specifically, the food network order software 150B may transmit a payment request to the wait device 120 to cause a payment screen (such as illustrated in FIG. 5C) to be displayed on the wait device GUI 210D. In step 415, the wait device 120 monitors or polls the GUI 210D for user entry of payment information. In step 420, the wait device 120 and/or the food network order software 150B determine whether payment information has been received. If not, the method returns to step 415 for further monitoring or polling for payment information. If payment information has been received in step 420, the method proceeds to step 425 in which the payment information is sent from the wait device 120 to the food network order software 150B. The food network order software 150B then transmits the payment information with information on the patron's food and/or beverage order (e.g., a total cost for the order) to the payment approval network server 130 for authentication and approval.

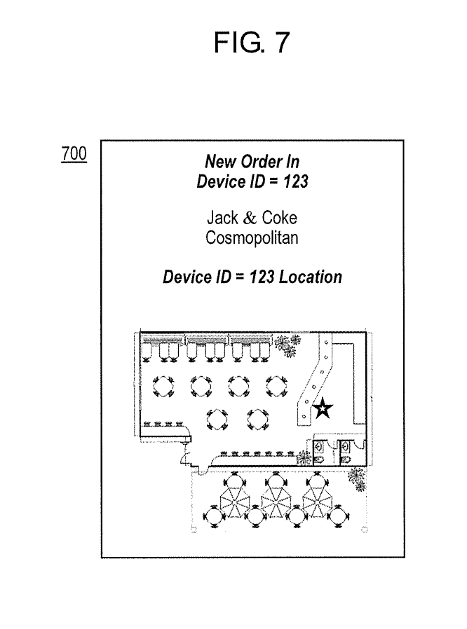

In step 430, the food network order software 150B determines whether the payment was approved by the payment approval network server 130 based on a payment approval response message received from the server 130. If the payment is not approved, the food network order software 150B transmits a “payment failed” message to the wait device 120 and returns to step 410 to cause the payment screen to be again displayed on the wait device GUI 210D. If the payment is approved, the food network order software 150B proceeds to step 435 and determines whether the user selection includes an order for the bar, for the kitchen, or both. Where the user selection is determined to include an order for the bar, the food network order software 150B proceeds in step 440 to send the user selection to the bar terminal 170 for display on the bar terminal GUI 170A (such as illustrated in FIG. 7). The food network order software 150B may send the user selection to the bar terminal 170 along with position information of the wait device 120 in order to enable the bar to deliver the order to the appropriate location.

Where the user selection is determined to include an order for the kitchen, the food network order software 150B proceeds in step 445 to retrieve an updated wait time estimate and an estimate of a time to prepare the user selection(s) from the restaurant information database 150G. In step 450, the food network order software 150B determines whether the current wait time is less than the estimate of the time to prepare the user food selection(s). If so, the food network order software 150B proceeds to step 455 in which the user food selection is sent to the kitchen terminal 160 for display on the kitchen terminal GUI 160A. If not, the method returns to step 445 in which the food network order software 150B continues to periodically query the restaurant information database 150G for updated wait times and times to prepare selection(s).

FIGS. 5A-5D illustrate various wait device graphic user interfaces (GUIs) 500A-500D that may be used in a system for smart food-line management.

FIG. 5A illustrates an initial GUI 500A that may be displayed when the patron is assigned to the wait device 120 by the host station 180, for example in step 315. As illustrated, the GUI 500A may display the wait device ID 210A, a current estimated wait time, and buttons that allow the user to display the bar and/or kitchen menu(s).

FIG. 5B illustrates another GUI 500B that can be displayed when the user has selected a menu (e.g., the kitchen menu). The GUI 500B may display the device ID 210A, the current estimated wait time, a menu with selectable options, and a submit button to cause menu selection(s) to be transmitted to the food network server 150.

Upon submission of the selection(s), the wait device 120 may display GUI 500C (e.g., in step 410), which includes the wait device ID 210A, the estimated wait time (which may have been updated), and a request payment for payment information (e.g., by insertion of credit or debit card into an appropriate card reader). In the illustrated embodiment, the wait device 120 may include a credit card magnetic stripe reader or chip reader.

Once payment is provided (e.g., via insertion of a credit card), the wait device 120 may display GUI 500D, which includes the wait device ID 210A, the estimated wait time, and buttons for entering a PIN associated with the payment card or other payment modality.

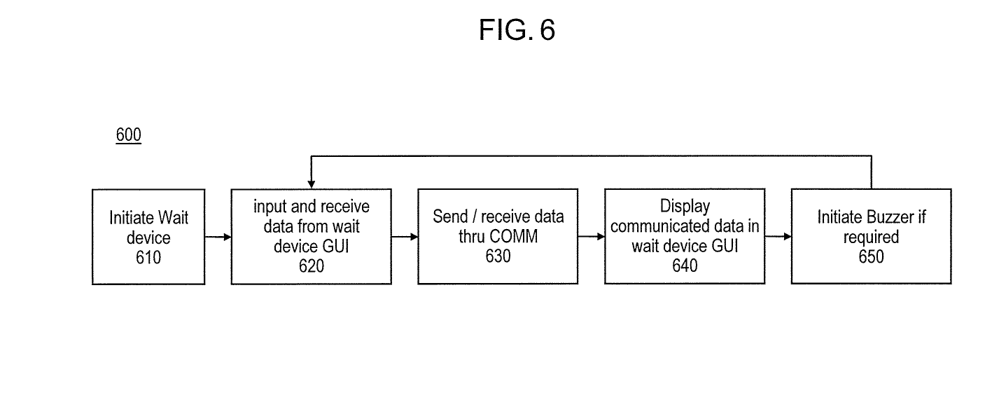

FIG. 6 is a flowchart illustrating an exemplary wait device method 600 that may be used in a system for smart food-line management. Method 600 may begin operation upon activation of a wait device 120. In step 610, the wait device base software 210B may begin execution to initiate the wait device 120. The wait device 120 may begin execution in a standby mode and may transition to an active mode upon being activated for use by a patron (e.g., in step 305). Once activated, the wait device 120 may receive information from the food network server 150 and, in turn, may a GUI 210D including the estimated wait time and the bar and/or kitchen menu(s). In step 620, user-inputted data (e.g., a menu selection by a user) may be received through the wait device GUI 210D (e.g., steps 320-325). In step 630, data may be sent and received through the wait device communication interface 250, for example to transmit the user-inputted data to the food network server 150 and receive an updated wait estimate from the food network server (e.g., step 335). In step 640, the communicated data received from the food network server 150 may be displayed on the wait device GUI 210D (e.g., step 335). In step 650, the wait device 120 may activate the buzzer 230A as needed (e.g., step 350).

FIG. 7 illustrate an exemplary bar terminal GUI 700 that may be used in a system for smart food-line management. Bar terminal GUI 700 may display an order that includes the wait device ID 210A of the wait device 120/200A that submitted the order, the ordered items (e.g., a “Jack & Coke” drink order and a “Cosmopolitan” drink order), and the location of the wait device 120/200A within the restaurant or other location. As illustrated, the location may be provided as a map of the restaurant in which the device location 120/200A is marked by a star.

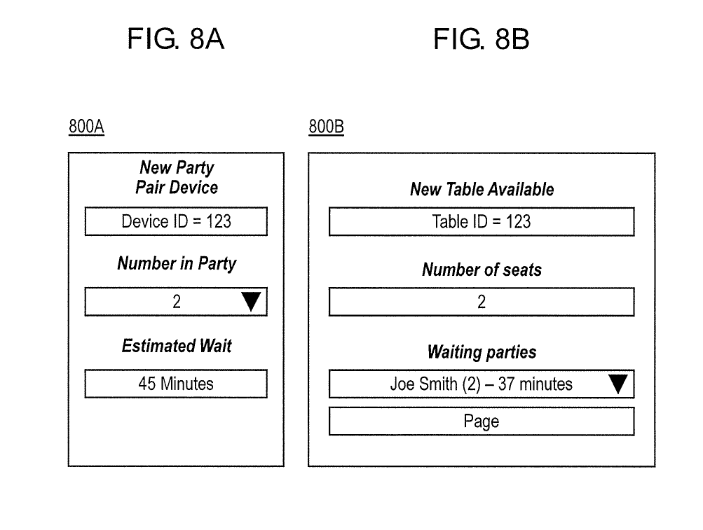

FIGS. 8A and 8B illustrate various host station GUIs 800A and 800B that may be used in a system for smart food-line management. FIG. 8A illustrates a host station GUI 800A that may be displayed when a wait device 120 is issued to a patron(s) by a host at the host station 180. Using the GUI 800A, the host may enter the identifier 210A of an available wait device 120/200A and the number of patrons in the party. Once such information is entered and transmitted by the host station 180 to the food network server 150, the wait time estimation software 150D may be executed to provide an estimated wait time to the host station GUI 180A and to the wait device 120/200A as to when a table may be ready for the party.

FIG. 8B illustrates a host station GUI 800B that may be displayed when a table becomes available. The host station GUI 800B includes the identifier of the available table, the number of seats, and a drop down menu of all parties waiting for a table with the same number of seats as the table (the drop down menu may further include the number of people in each party and the amount of time each party has been waiting). Once a host has selected a party to assign to the available table, the host may select the “page” button to trigger a notification to be sent to the selected party's wait device 120 to cause activation of the buzzer 230A on the user's wait device 120/200A.

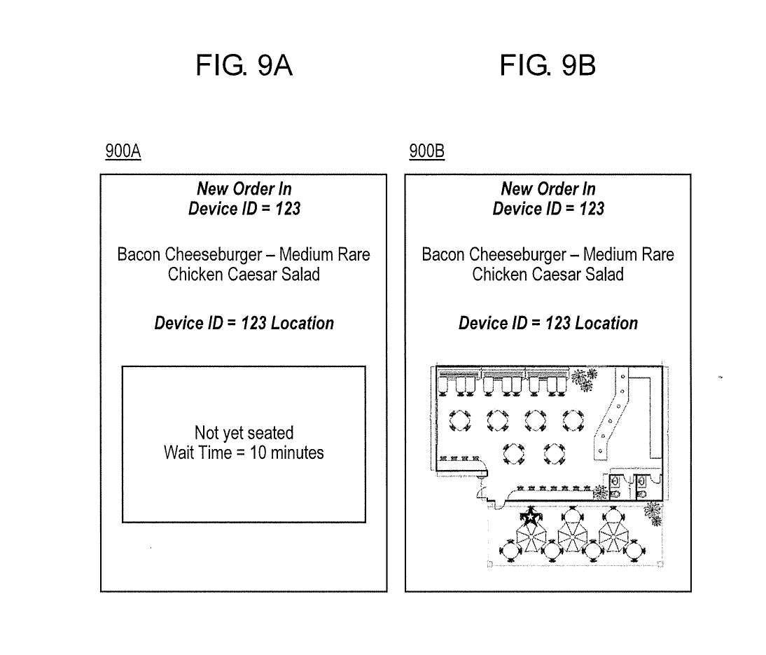

FIGS. 9A and 9B illustrate various kitchen terminal device GUIs 900A and 900B that may be used in a system for smart food-line management. FIG. 9A illustrates a kitchen terminal GUI 900A that may be displayed when an order from the kitchen menu has been submitted through a wait device 120/200A. Kitchen terminal GUI 900A may include the wait device ID 210A of the wait device 120/200A through which the order was placed, a list of food items ordered (e.g., “bacon cheeseburger-medium rare” and “chicken Caesar salad”), device location of the wait device 120/200A, seating status of the patron's party, and current wait time estimated for the patron. The device location information may be updated in response to the food network server 150 receiving updated information on the location of the wait device 120/200A such as information that the wait device 120/200A is within a communication range of a table location beacon 140.

FIG. 9B illustrates a kitchen terminal GUI 900B that may be displayed when the wait device 120/200A has submitted an order from the kitchen menu that is accompanied by an approved payment and the associated party has been seated (e.g., as indicated by the wait device 200A coming in contact with a table beacon 140).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A system for smart food-line management, the system comprising:
a plurality of wait devices, each wait device including a memory storing a unique identifier and a wireless network communication interface configured to communicate the unique identifier over a communication network;
a beacon associated with a table and configured to communicate wirelessly with a wait device of the plurality of wait devices within a communication range of the beacon;
a kitchen or bar terminal including a user interface and a network communication interface configured to communicate over the communication network; and
a food network server including a network communication interface configured to communicate wirelessly with the plurality of wait devices and to communicate with the kitchen or bar terminal,
wherein the food network server is configured to:
receive, via the communication interface of the food network server, a communication from at least one of the plurality of wait devices and the beacon that a particular wait device is within a communication range of the beacon, the received communication including the unique identifier stored by the particular wait device, and
transmit to the kitchen or bar terminal, via the network communication interfaces of the kitchen or bar terminal and of the food network server, location information for the particular wait device determined based on the received communication indicating that the particular wait device is within the communication range of the beacon.

2. The system of claim 1, wherein each wait device further includes a user interface configured to receive a user input selection of a menu item,
the wireless network communication interface of each wait device is further configured to communicate the user selection of the menu item to the food network server over the communication network, and
the food network server transmits to the kitchen or bar terminal, via the network communication interfaces of the kitchen or bar terminal and of the food network server, the user selection of the menu item with the location information for the particular wait device.

3. The system of claim 2, further comprising:
a payment approval network server in communication with the food network server,
wherein the food network server is configured to:
receive from the wait device across the communication network payment information for the menu item of the user input selection;
transmit a payment approval request including the received payment information to the payment approval network server; and
transmit the user selection for the menu item to the kitchen or bar terminal only if a payment approval is received from the payment approval network server.

4. The system of claim 2, wherein the food network server is further configured to retrieve from a database a menu including a plurality of menu items and to transmit the retrieved menu across the communication network to the particular wait device for output through a user interface of the particular wait device,
wherein the user input selection is a selection of a menu item from the retrieved menu.

5. The system of claim 1, wherein the food network server is further configured to retrieve from a database a current wait time associated with the unique identifier of the particular wait device, and to transmit the retrieved current wait time across the communication network to the particular wait device for output through the user interface of the particular wait device.

6. The system of claim 1, wherein the food network server is further configured to determine whether a table is available for a patron associated with the particular wait device, and to transmit a notification to the particular wait device upon determining that a table is available for the patron associated with the particular wait device.

7. The system of claim 1, wherein each wait device includes a payment card reader, and
wherein the food network server is configured to receive from the particular wait device across the communication network payment information read by the payment card reader of the particular wait device.

8. A system for smart food-line management, the system comprising:
a wait device including a memory storing a unique identifier, a user interface configured to receive a user input selection, and a network communication interface configured to communicate wirelessly over a communication network;
a kitchen terminal device including a user interface and a network communication interface configured to communicate over the communication network; and
a food network server including a network communication interface configured to communicate with the wait device and the kitchen terminal device across the communication network,
wherein the food network server is configured to:
receive via the user device a user input selection of a menu item and the unique identifier of the wait device;
in response to receiving the user input selection of the menu item and the unique identifier of the wait device, retrieve from a database a current wait time associated with the unique identifier of the wait device and an estimated time to prepare the menu item of the user input selection; and
upon determining that the current wait time is less than the estimated time to prepare the menu item, transmit an order for the menu item of the user input selection to the kitchen terminal device.

9. The system of claim 8, wherein the food network server is configured to determine a location of the wait device according to wireless communications of the wait device, and to identify the determined location of the wait device in the order for the menu item transmitted to the kitchen terminal device.

10. The system of claim 9, further comprising:
a beacon associated with a table and configured to communicate wirelessly with the wait device when the wait device is within a communication range of the beacon,
wherein the food network server is configured to determine the location of the wait device based on a wireless communication between the wait device and the beacon, and to identify the table associated with the beacon as the determined location in the order.

11. The system of claim 8, further comprising:
a payment approval network server in communication with the food network server,
wherein the food network server is configured to:
receive from the wait device across the communication network payment information for the menu item of the user input selection;
transmit a payment approval request including the received payment information to the payment approval network server; and
transmit the order for the menu item of the user input selection to the kitchen terminal device only if a payment approval is received from the payment approval network server.

12. The system of claim 8, wherein the food network server is further configured to retrieve from the database the current wait time associated with the unique identifier of the wait device, and to transmit the retrieved current wait time across the communication network to the wait device for output through the user interface of the wait device.

13. The system of claim 8, wherein the food network server is further configured to retrieve from the database a menu including a plurality of menu items and to transmit the retrieved menu across the communication network to the wait device for output through the user interface of the wait device,
wherein the user input selection is a selection of a menu item from the retrieved menu.

14. The system of claim 8, wherein the wait device includes a payment card reader, and
wherein the food network server is configured to receive from the wait device across the communication network payment information read by the payment card reader of the wait device.

15. A system for smart food-line management, the system comprising:
a plurality of wait devices, each wait device including a memory storing a unique identifier and a wireless network communication interface configured to communicate the unique identifier over a communication network;
a kitchen or bar terminal including a network communication interface configured to communicate over the communication network; and
a food network server including a network communication interface configured to communicate wirelessly with the plurality of wait devices and to communicate with the kitchen or bar terminal, the food network server further including a memory configured to store information on available tables including location information of the available tables,
wherein each respective wait device is configured to:
receive, from the food network server, the information on the available tables;
receive, using a user interface of the respective wait device, a user input selection of a table among the available tables; and
communicate, using the wireless network communication interface of the respective wait device, the user input selection of the table to the food network server over the communication network, and
wherein the food network server is configured to:
receive user input selections of tables from the plurality of wait devices; and
in response to receiving a user input selection of a particular table from one of the plurality of wait devices, transmit to the kitchen or bar terminal, via the network communication interfaces of the food network server and the kitchen or bar terminal, location information of the particular table and the unique identifier of the one wait device.

16. The system of claim 15, wherein each respective wait device is further configured to receive, using the user interface of the respective wait device, a user input selection of a menu item, and to communicate, using the wireless network communication interface of the respective wait device, the user input selection of the menu item to the food network server over the communication network, and
the food network server is configured to transmit to the kitchen or bar terminal, via the network communication interfaces of the food network server and the kitchen or bar terminal, the user input selection of the menu item with the location information of the particular table.

17. The system of claim 16, further comprising:
a payment approval network server in communication with the food network server,
wherein the food network server is configured to:
receive from the wait device across the communication network payment information for the menu item of the user input selection;
transmit a payment approval request including the received payment information to the payment approval network server; and
transmit the user selection for the menu item to the kitchen or bar terminal only if a payment approval is received from the payment approval network server.

18. The system of claim 16, wherein the food network server is further configured to retrieve from a database a menu including a plurality of menu items and to transmit the retrieved menu across the communication network to the particular wait device for output through the user interface of the particular wait device,
wherein the user input selection is a selection of a menu item from the retrieved menu.

19. The system of claim 15, wherein the food network server is further configured to retrieve from a database a current wait time associated with the unique identifier of the particular wait device, and to transmit the retrieved current wait time across the communication network to the particular wait device for output through the user interface of the particular wait device.

20. The system of claim 15, wherein each wait device includes a payment card reader, and
wherein the food network server is configured to receive from the particular wait device across the communication network payment information read by the payment card reader of the particular wait device.
